(19) United States
(12) Patent Application Publication
(10) Pub. No.: US 2003/0026971 A1
(43) Pub. Date: Feb. 6, 2003

(54) Touch sensitive membrane

(76) Inventors: D. Robert Inkster, Victoria (CA); David M. Lokhorst, Victoria (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/200,295

(22) Filed: Jul. 23, 2002

(30) Foreign Application Priority Data
Jul. 24, 2001 (CA) 2, 353, 697

(51) Int. Cl. B32B 9/00; B32B 3/26

(52) U.S. Cl. 428/304.4; 428/318.4

(57) ABSTRACT

An input device has a flexible surface on which are formed deflection sensors. The flexible surface can be deformed against an adjacent resilient layer. The deflection sensors detect the deflection of the surface. Electronic circuits for processing signals from the deflection sensors to yield information regarding the locations and magnitudes of forces deflecting the surface may be deposited all, or in part on the flexible surface. The input device may be combined with a display to yield a touch-sensitive display suitable for use in a wide range of applications.

### CROSS-REFERENCE TO RELATED APPLICATIONS

This application claims the benefit of the filing date of Canadian patent application No. 2,353,697 filed on Jul. 24 2001.

### TECHNICAL FIELD

This invention relates to surfaces which may be used as input devices for computers or other types of electronic equipment. More specifically, the invention relates to input devices comprising surfaces which can measure the location(s) and magnitude(s) of a force (or several forces) applied to their surfaces.

### EXAMPLE APPLICATIONS OF THE INVENTION

This invention has practical application in a number of fields. Implemented in a small form factor, it may be used in mobile devices such as hand-held telephones, remote control units, hand-held computers, musical instruments, or “personal digital assistants.” Implemented on a larger scale, it may be used as a wall-mounted electronic “white-board,” or as an interactive table- or desk-top surface. In the preferred implementation, this invention combines a touch-sensitive membrane with an electronic display.

### BRIEF DESCRIPTION OF THE DRAWINGS

In Figures which illustrate non-limiting embodiments and applications of the invention:

FIG. 1 shows one application of this invention in a device which has a flat surface upon which a person applies a force by means of a stylus. The touch-sensitive membrane is used to detect the location and magnitude of the force applied by the stylus as described in this disclosure.

FIG. 2 shows a second application of this invention in a device which is flexible and which detects the location and force applied by each of a user's fingers simultaneously.

FIG. 3 shows a third application of this invention whereby a wall-mounted touch-sensitive membrane is integrated with a flexible digital display. The touch-sensitive membrane measures the location and force applied by a user's hands and/or other objects (such as a stylus or eraser-shaped block).

FIGS. 4a and 4b show cross-sections through a touch-sensitive membrane according to the invention.

FIG. 5 is a cross section through a touch-sensitive membrane which illustrates a means of measuring the deflection of the membrane using “optical cavities.”

FIG. 6 is a plan view which illustrates an arrangement of sensors in a touch-sensitive membrane.

FIGS. 7a and 7b illustrate another means of measuring the deflection of the membrane by measuring the proximity of the membrane to a substrate.

FIG. 7c illustrates touch-sensitive apparatus having strain gauges for detecting forces applied to a membrane.

FIG. 8 is a cross-section which illustrates a variation of the invention.

### DESCRIPTION

Throughout the following description specific details are set forth in order to provide a more thorough understanding of the invention. However, the invention may be practiced without these particulars. In other instances, well known elements have not been shown or described in detail to avoid unnecessarily obscuring the present invention. Accordingly, the specification and drawings are to be regarded in an illustrative, rather than a restrictive, sense.

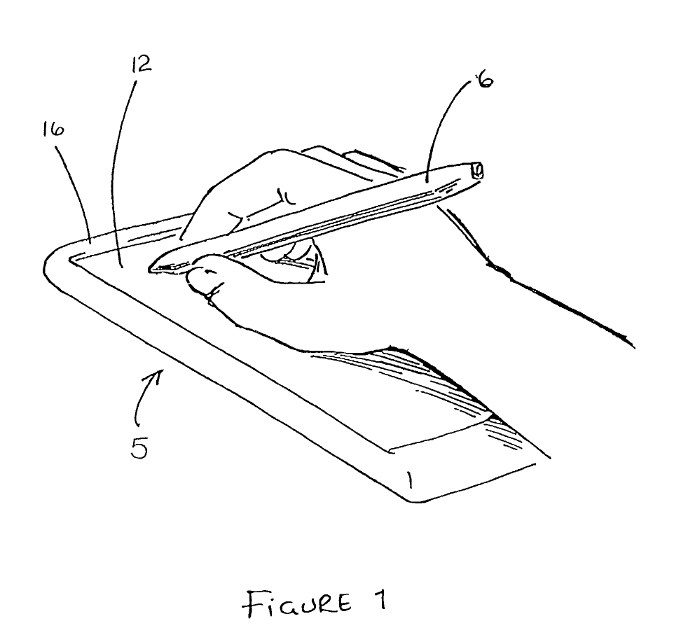

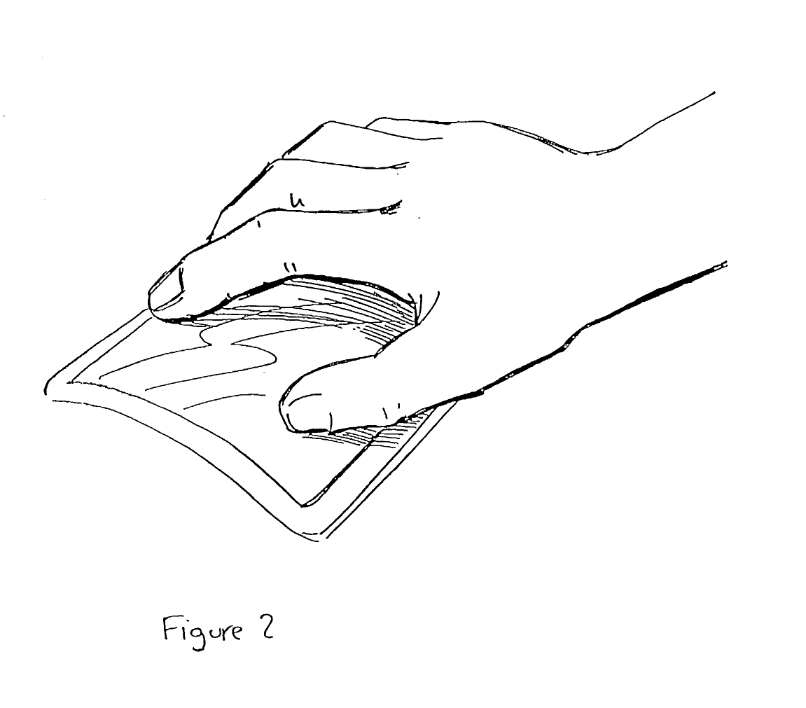

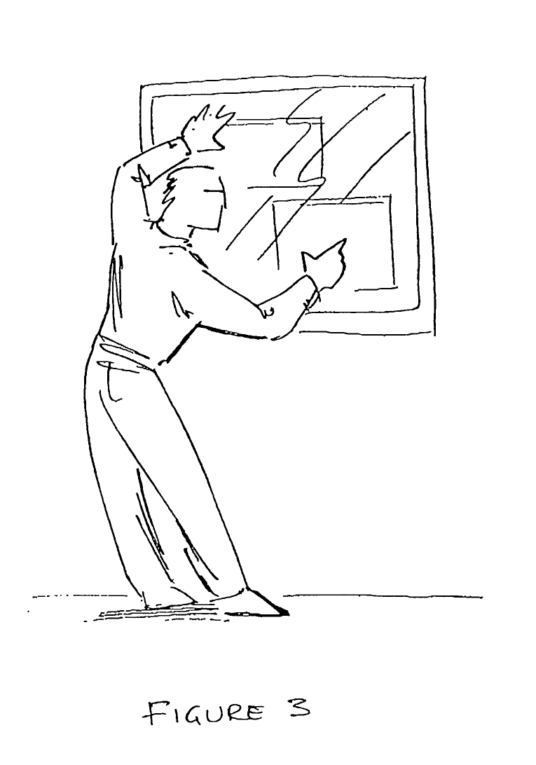

FIGS. 1, 2, and 3 show applications (i.e. example implementations) of the invention. FIG. 1 shows a touch-sensitive apparatus 5. A user is using a stylus 6 to press on a flexible surface 12 of apparatus 5. FIG. 2 shows a touch-sensitive apparatus having an integrated display. A user is pressing on the touch-sensitive surface with his fingers. FIG. 3 shows a large touch-sensitive surface having an integrated display screen. All of these implementations share common features.

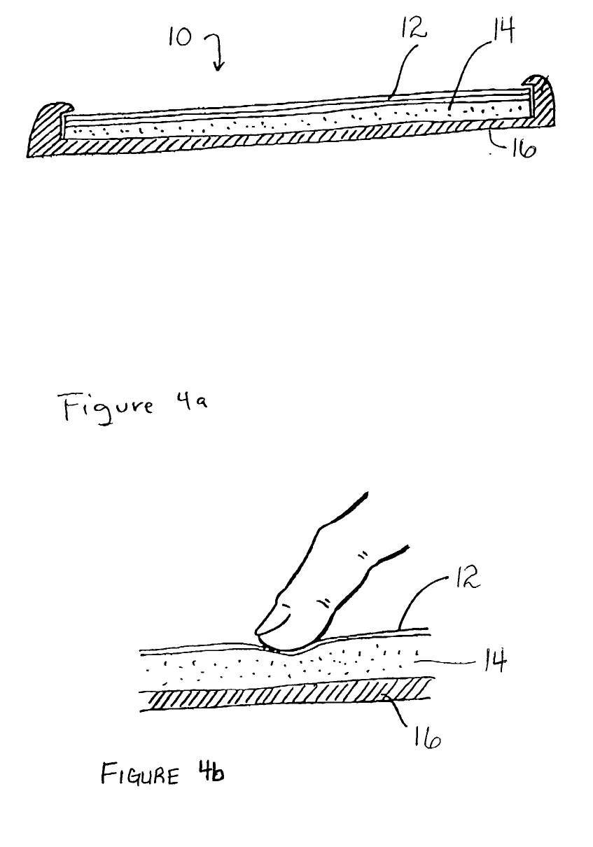

FIG. 4a shows a cross-section through a touch-sensitive membrane 10. A flexible surface 12 overlies a compressible elastic material 14. Material 14 could comprise, for example, a polyurethane foam. Flexible surface 12 is preferably (but not necessarily) adhered to material 14. Flexible surface 12 may comprise a surface of a membrane disposed adjacent to elastic material 14. Flexible surface 12 could be integral with elastic material 14. Elastic material 14 sits on a base 16.

When a force is applied to flexible surface 12, as shown in FIG. 4b, flexible surface 12 is deflected downward in a locality where the force is applied. The underlying elastic material 14 is compressed. The greater the applied force, the greater the deflection of flexible membrane 12.

Measuring the magnitude of downward displacement of flexible membrane 12 at a sufficient number of locations provides a means for identifying the locations at which one or more forces are applied to flexible surface 12 and determining the magnitude of the force applied at each such location.

Recently, techniques have been developed for creating micro-electronic circuits on thin, flexible, plastic substrates. The circuits do not significantly affect the flexibility of the substrates and remain functional as the substrates flex. These techniques can be used to create integrated circuits including components such as transistors, light emitting diodes, and photo-transistors, for example. It has previously been necessary to fabricate such components on hard inflexible substrates (such as silicon or glass). Given the availability of these techniques, this invention provides a novel means for detecting and measuring the deflection of a surface membrane.

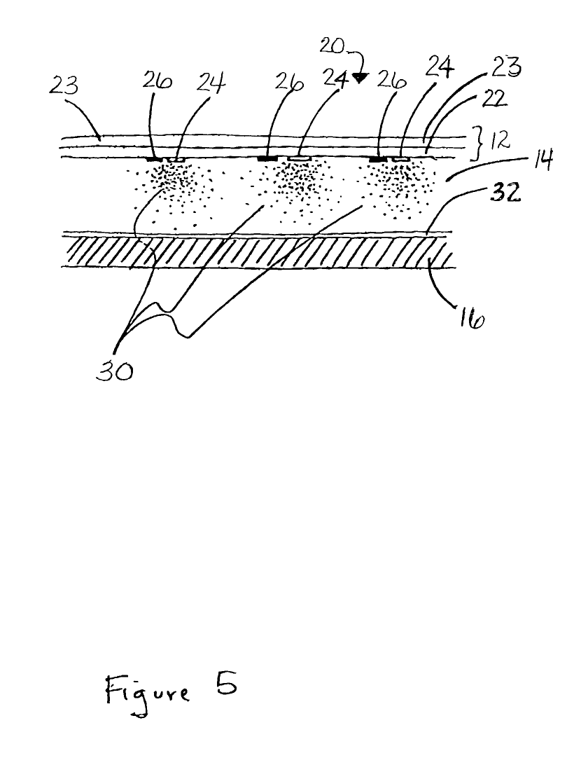

FIG. 5 shows one embodiment of this invention. Flexible surface 12 comprises a flexible substrate 22, suitably equipped with LEDs 24 and photo-sensors 26 facing toward base 16. Flexible substrate 22 may be made of a suitable plastic. The photo-sensors may comprise phototransistors or photo diodes, for example. LEDs 24 and photo-sensors 26 are formed on substrate 22. In this embodiment, the LEDs and photo-sensors are arranged in pairs (one LED and one photo-sensor per pair). The LED and photo-sensor of each pair are preferably located closely to one another. A durable wear surface 23 may be provided over substrate 22.

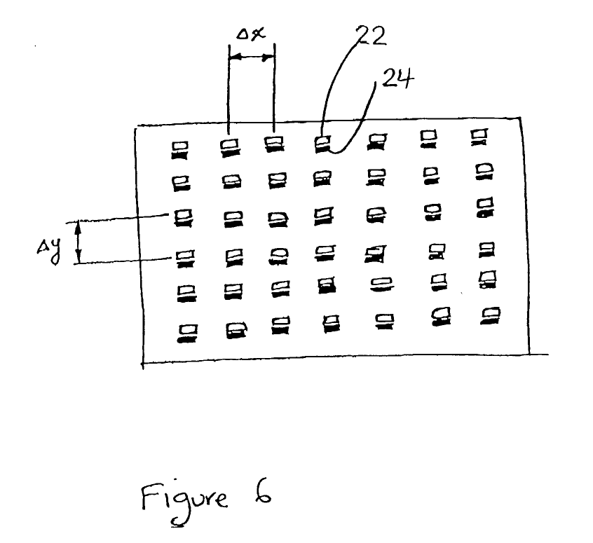

FIG. 6 shows a plan view of the device of FIG. 5. FIG. 6 illustrates the arrangement of the LED/photo-sensor pairs schematically. It is preferred (but not required) that the LED/photo-sensor pairs be arranged in a generally regular row-column format, with the spacing between rows and columns (Δx and Δy) roughly equivalent. The optimum spacing depends on the desired accuracy of the device, with a greater number of sensor providing greater accuracy. The spacing (Δx and Δy) is preferably in the range of about 0.5 mm to about 25 mm, and is preferably about 5 mm if the application calls for detecting multiple touches from a finger.

The compressible elastic material 14, in this case, is somewhat translucent. Material 14 has a large number of very small light-scattering centres. Material 14 may comprise, for example, a natural-coloured polyurethane foam, 1 mm to 6 mm thick, which has small bubbles which serve as the light-scattering centres. Light emitted from each of LEDs 24 enters material 14 and individual light rays reflect multiple times as they hit the scattering centres. This results in a so-called “optical cavity” 30 (FIG. 5) which is characterized by having fully scattered (isotropic) light. When flexible surface 12 is deflected downward, the elastic material 14 compresses and the intensity of light measured by the photo-sensor 24 at the location is changed. Signals from photo-sensors 26 may be processed to determine the location(s) and magnitude(s) of one or more forces applied to flexible surface 12. The use of this effect to measure deflection is described more fully in Reimer et al, PCT patent publication No. WO 99/04234 which is incorporated herein by reference. A reflective layer 32 may be provided on base 16.

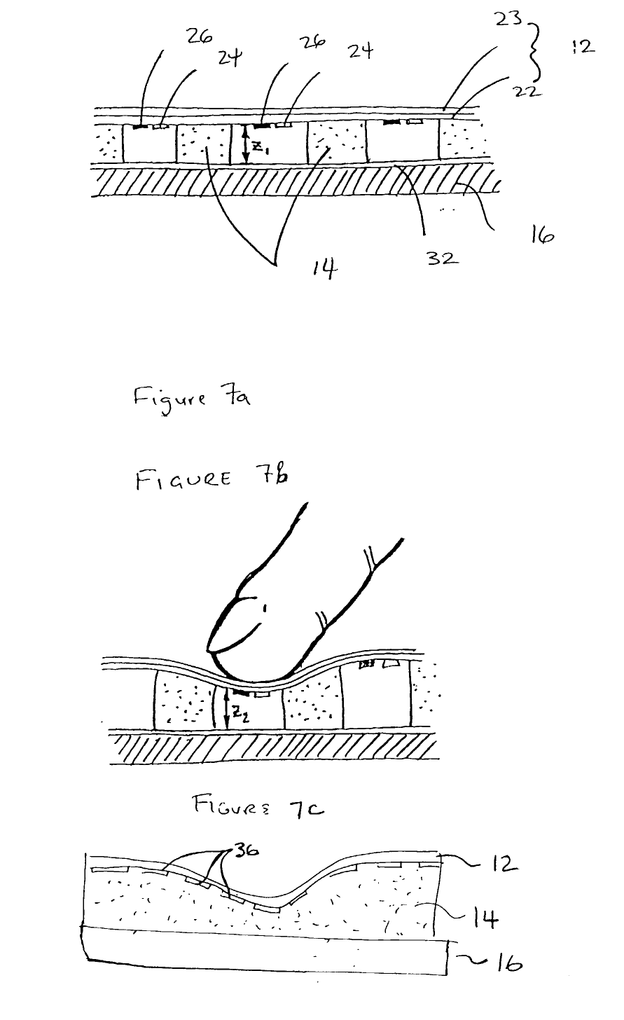

FIG. 7a shows apparatus according to another embodiment of this invention. As before, LEDs 24 and photo-sensors 26 are deposited on a flexible plastic substrate 22 in pairs and located as shown in FIG. 6. In this case, however, the elastic material 14 is perforated so as not to directly underlie the LED/photo-sensor pairs. A reflective layer 32 is placed underneath elastic material 14. Polymerized mylar is an example of a suitable material for layer 32. As shown in FIG. 7b, deflection of flexible membrane 12 causes the distance, z, between the LED/photo-sensor pair and reflective layer 32 at that location to lessen. Therefore the light detected by the photo-sensor 26 will change. Again, signals from photo-sensors 26 can be processed to determine the location(s) and magnitude(s) of forces applied to flexible surface 12.

In another embodiment of this invention, shown in FIG. 7c, substrate 22 is outfitted with a number of micro-electronic strain gauges 36. In this case, LEDs and photo-sensors are not required to measure the deflection of the membrane; output signals from strain gauges 36 provide a measure of the deflection of substrate 22. These output signals can be processed to determine the location(s) and magnitude(s) of forces applied to flexible surface 12.

For all of the aspects of the invention described above, it is preferable to provide a signal processing unit. The signal processing unit monitors output signals from the sensors. The output signals are typically electrical signals output from the photo-sensors 26 or strain gauges 36. The output voltages or currents of the sensors (be they any of those described above) are provided to the signal processing unit. The signal processing unit preferably includes at least one analog-to-digital convertor, current regulators for the LEDs (where necessary) and a digital processor. The digital processor preferably implements software which calibrates each sensor, and which computes the location of pressures applied to flexible surface 12 by interpolation between nearby sensors.

Multiple points of contact may be simultaneously measured.

Some embodiments of the invention incorporate flexible displays onto the touch-sensitive surface. The displays may be implemented as an array of thin film transistors (TFTs) deposited on substrate 22.

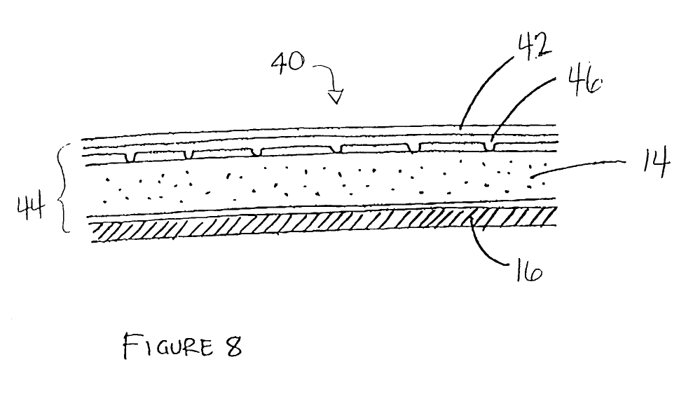

FIG. 8 shows apparatus 40 which combines a display and a touch-sensitive surface according to one aspect of the invention. Apparatus 40 comprises a flexible display 42 on top of an underlying pressure sensitive surface 44. For illustrative purposes, the underlying pressure sensitive surface is shown to have dimpled membrane 46, a compressible elastic medium 14 and a base layer 16. Pressure sensors (not shown) are embedded in the underlying pressure sensitive surface. One novel feature of some embodiments of this invention is the combination of a flexible plastic substrate TFT display with a touch-sensitive surface.

It will be appreciated that the invention can be embodied according to various combinations and sub-combinations of the features described above. At a basic level, devices according to the invention comprise a flexible surface on a resilient elastic material. Deflection sensors are disposed on the flexible surface. The deflection sensors measure the deflection of the flexible membrane and preferably comprise electronic devices/circuits which have been deposited directly onto the flexible surface. The flexible surface may comprise a flexible membrane bearing the position sensors which has been laminated to the resilient elastic material.

In a preferred embodiment of the invention the deflection sensors comprise LED/photo-sensor pairs. The LED/photo-sensor pairs may produce output signals which depend on the changing intensity of light in an optical cavity or may produce output signals which vary with the proximity to a base layer. In alternative embodiments of the invention the deflection sensors comprise strain gauges on the flexible surface. The strain gauges produce output signals which vary with strains in the flexible surface.

Some embodiments of the invention incorporate a display. The display may be laminated to an underlying pressure sensitive surface to yield a touch-sensitive display.

Devices according to the invention may include a signal processing means. The signal processing means preferably processes information regarding the signals produced by the deflection sensors to provide information regarding the locations and magnitudes of forces applied to the flexible surface.

The processing means may comprise electronic circuitry which has been deposited directly onto the membrane (partially or entirely).

As will be apparent to those skilled in the art in the light of the foregoing disclosure, many alterations and modifications are possible in the practice of this invention without departing from the scope thereof. For example, the deflection sensors may comprise other devices deposited on the flexible surface and capable of measuring deflections of the flexible surface. For example, the deflection sensors could comprise small coils patterned on the flexible surface which detect proximity to a ferromagnetic base layer (not shown). Accordingly, the scope of the invention is to be construed in accordance with the substance defined by the following claims.

What is claimed is:

1. A touch-sensitive device comprising:
a layer of compressible resilient material;
a flexible surface on the compressible resilient material; and,
a plurality of deflection sensors on the flexible surface.

2. A touch-sensitive device as in claim 1 wherein each of the deflection sensors comprises one or more flexible components on the flexible surface.

3. The touch-sensitive device of claim 2 wherein the flexible components comprise strain gauges.

4. The touch-sensitive device of claim 2 wherein the flexible components of each of the deflection sensors comprise a light detector and the touch-sensitive device comprises at least one light source.

5. The touch-sensitive device of claim 4 wherein the compressible resilient material is translucent.

6. The touch-sensitive device of claim 5 wherein the compressible resilient material comprises a foam.

7. The touch-sensitive device of claim 6 wherein the compressible resilient material comprises a polyurethane foam.

8. The touch-sensitive device of claim 4 wherein the flexible components of each of the deflection sensors comprises a light source.

9. The touch-sensitive device of claim 8 comprising a reflective layer on a side of the compressible resilient material away from the flexible surface.

10. The touch-sensitive device of claim 9 wherein the compressible resilient material comprises an aperture underlying each of the deflection sensors.

11. The touch-sensitive device of claim 8 wherein the compressible resilient material is translucent.

12. The touch-sensitive device of claim 11 wherein the compressible resilient material comprises a foam.

13. The touch-sensitive device of claim 12 wherein the compressible resilient material comprises a polyurethane foam.

14. The touch-sensitive device of claim 1 wherein the deflection sensors comprise coils deposited on the flexible layer.

15. The touch-sensitive device of claim 14 comprising a ferromagnetic base layer on a side of the compressible resilient material away from the flexible surface.

16. The touch-sensitive device of claim 1 wherein the deflection sensors are arranged in a regular array.

17. The touch-sensitive device of claim 16 wherein the deflection sensors are arranged in a rectangular array.

18. The touch-sensitive device of claim 17 wherein a spacing between adjacent ones of the deflection sensors is in the range of about 0.5 mm to about 25 mm.

19. The touch-sensitive device of claim 18 wherein the spacing between adjacent ones of the deflection sensors is in the range of 5 mm±1 mm.

20. The touch-sensitive device of claim 1 comprising a flexible display on the flexible surface.

21. The touch-sensitive device of claim 20 wherein the flexible display comprises an array of thin film transistors on the flexible surface.

22. The touch-sensitive device of claim 1 comprising a data processor connected to receive signals from the deflection sensors and configured to determine at least one point at which a force is being applied to the touch-sensitive device from the signals.

23. The touch-sensitive device of claim 22 wherein the data processor comprises at least some flexible electronic devices on the flexible surface.
